(19) United States
(12) Patent Application Publication
(10) Pub. No.: US 2003/0124369 A1
(43) Pub. Date: Jul. 3, 2003

(54) Packaging film and a method manufacturing a packaging film

(76) Inventors: Stephen John Meyer, Wellington (NZ); Graeme Morrow Ward, Pukerua Bay (NZ); Annant Narayan, Tawa (NZ); Thomas Hunter Bainbridge, Wellington (NZ)

Correspondence Address: Stephen T Scherrer, McDermott Will & Emery, 227 West Monroe Street, Chicago, IL, 60606-5096, US

(21) Appl. No.: 10/221,913

(22) PCT Filed: Mar. 19, 2001
(86) PCT No.: PCT/NZ01/00040

(30) Foreign Application Priority Data
Mar. 17, 2000 (NZ) NZ 503501

(51) Int. Cl. B32B 27/08

(52) U.S. Cl. 428/515; 428/523

(57) ABSTRACT

The present invention provides a packaging film including: (a) an outer layer comprising an ionomer to provide thermal resistance; and (b) an inner layer comprising a polymeric material having a sealing temperature lower than the sealing temperature of the outer layer. The invention also provides a method of making a paCkaging film as described above, which includes the steps of (a) co-extruding a first layer comprising an ionomer and a second layer comprising a polymeric material having a sealing temperature lower than the first layer; and (b) cooling the co-extruded film. A method of packaging a food product is also provided.

This invention relates generally to the art of packaging films, in particular to films useful in the packaging of food and other products, especially perishable food products, and to a method of making such films.

### BACKGROUND

Packaging films, and especially films of polyolefin materials, have been used in the past to package various articles including perishable food-products that require protection from the environment.

Bags made from heat shrinkable polymeric films have wide acceptance for poultry, fish, red meats and processed meats packaging. One of the benefits of using heat-shrinkable packaging is the ability to provide an intimate contact between the product and the film packaging to prevent ice build up between the product and the film packaging during freezing. This intimate contact prevents problems such as freezer burn and moisture loss. At the same time as premium perishable food products are produced, many processors also produce frozen products which often require a separate packaging line. Many frozen perishable foods are either over-wrapped or bagged without vacuum packaging where they are classified as commodity food products. In the past this has not been easy to do because traditionally a different film is used for wrapping chilled cuts as opposed to those cuts which are selected to be frozen. This has meant that two packaging lines are needed, with one line dedicated to cuts which will be subsequently frozen and one line dedicated to cuts that are to remain chilled.

With the increased focus on food safety and product traceability processors desire to put commodity products through the same processing lines as non-commodity (premium) products. In order to do this it is necessary to develop a low cost, hot water shrinkable material that will have the required thermal resistance to the heat sealing and shrinking processes used for non-commodity products.

It is an object of the invention to provide a packaging film that overcomes some of these known difficulties, or which at least provides the public with a useful alternative.

### STATEMENT OF INVENTION

In a first aspect the present invention provides a non-oxygen barrier packaging film including:

(a) an outer layer comprising an ionomer to provide thermal resistance and

(b) an inner layer comprising a polymeric material having a sealing temperature lower than the sealing temperature of said outer layer.

Preferably, the packaging film may further include a core layer.

Preferably, said inner layer and said core layer may further include a tinting material.

Preferably, the packaging film is transparent.

Preferably, said inner layer or said core layer comprises a polymeric material selected from the group consisting of: ethylene vinyl acetate, linear low density polyethylene, low density polyethylene, very low density polyethylene, or metallocene catalysed polyethylenes and blends thereof.

Preferably, the packaging film has a gauge of between 19-120 microns.

More preferably the packaging film has a gauge of between 40-80 microns.

Most preferably, each layer of the packaging film has gauge of between 9-60 microns.

Preferably the packaging film is oriented.

More preferably the packaging film is biaxially oriented.

Preferably said tinting material is selected from a range of known dyes or pigments that are food approved additives.

In a second aspect of the present invention there is provided a method of making a non-oxygen barrier packaging film which includes the steps of

(a) co-extruding a first layer comprising an ionomer and a second layer comprising a polymeric material having a sealing temperature lower than said first layer; and

(b) cooling the co-extruded film.

Preferably, the method includes the further step of heating the co-extruded film to its orientation temperature range and stretching and orienting the heated film.

Preferably, the co-extrusion step is a tubular co-extrusion step.

Most preferably, the film produced in the tubular co-extrusion step is biaxially oriented and stretched by a trapped bubble technique.

Preferably the film produced in the tubular co-extrusion step has said first layer is the outer layer and said second layer is the inner layer.

In a further aspect of the present invention there is provided a method of packaging a food product, including the steps of

(a) taking a heat shrinkable film as described above;

(b) wrapping a food product in said film such that said first layer is the outer layer and said second layer is the inner layer;

(c) heat sealing together the edges of said film about said food product; after vacuum packaging; and

(d) heat shrinking said film about said food product.

Preferably, the film is a co-extruded tubular film and step (b) involves cutting a length of said tube and locating said food product within the tube. Preferably, the film is a co-extruded tubular film and step (c) involves heat sealing each end of said tube.

Preferably, one end of the tubular film is heat sealed prior to locating the food product in the tube.

Preferably, said heat shrinking is achieved by a hot air stream or a hot water bath.

Preferably, the method further includes the step of printing onto the outer layer of said film.

The term “sealing temperature” as used in this specification is intended to refer to the temperature at which the layers of the packaging film are welded or sealed together, when passed through, for example a thermal impulse sealer. The outer layer will resist the thermal impulse more than the inner layer with the inner layer becoming more tacky than the outer layer and enabling a weld or seal to be formed.

The term “ionomers” as used in this specification includes ionomers that are derived from acid copolymers by wholly or partially neutralizing the acid moiety of the acid copolymer with a cation, such as sodium or zinc. Acid copolymers are well known and generally comprise an olefin monomer (such as ethylene) which is copolymerized with an acid comonomer (such as acrylic acid or methacrylic acid).

The term “oriented” is used to define a polymeric material that has been heated and stretched to realign the molecular configuration, the stretching being accomplished typically by a trapped bubble process. Such a process is well-known in the art. A thermoplastic material stretched in one direction only is uniaxially oriented and a material stretched in a longitudinal as well as the transverse direction is biaxially oriented.

Further aspects of the invention will become apparent with reference to the following description and accompanying examples thereof.

### DETAILED DESCRIPTION

The films of the invention may be produced by a conventional tubular coextrusion technique. In this technique a hot melt of resins is extruded through an annular circular die. The tube that is formed is cooled and flattened. The resulting tape is then fed through a hot water bath, at a temperature of from about 80-98° C. This heating step is done just prior to orienting the film. The orientation temperature ranges are well known for many polymeric materials and are generally below the melting point of the film. Preferably films according to the invention are heated from about 80 to 98° C. On leaving the bath the tube is then inflated and blown to give a wall thickness in the blown tube of about 19-120 microns. This “trapped bubble” technique is known in the art. The tube is then drawn away from the nip rollers that trap the air bubble. The rate of draw is controlled to provide the longitudinal stretch. The film is then rapidly cooled to set the orientation and rolled up to give the desired biaxially oriented bi-layer film. By this technique, shrinkability is imparted to the film by the orientation of the film during its manufacture. This allows the film to shrink or, if restrained, to create shrink tension within the packaging film on exposure to heat, for example, in a hot water bath or by exposure to hot air. In a typical process, the degree of stretch in both the longitudinal and transverse directions can be varied to impart the desired degree of shrinkability to the film upon subsequent heating.

Premade bags or bags made from rollstock at point of use from such heat shrinkable film are supplied to a meat packer being sealed at one end to receive a meat product. After the cut of meat is placed in the bag, the bag will be closed as part of a vacuum packaging process. Afterwards each food product is heat shrunk by applying heat, for example, by immersing the filled bag in a hot water bath or by conveying it through a hot air or hot water tunnel.

The product typically has a free shrink in the transverse direction of 35-75% and in the machine (longitudinal) direction of 25-65% over the temperature range 70-98° C.

The product is typically sealed at a temperature of 110-160° C. The product is also preferably internally dusted (for example with starch) to prevent blocking during manufacture.

### EXAMPLE 1

A packaging film was produced in accordance with the process described above. The outer layer was extruded from the Du Pont Surlyn™ 1601B2 resin, which has a density of 0.93 g/cm³ at a temperature of 165-185° C. The melt flow index of Surlyn™ is 0.13 g/10 min.

The inner layer was extruded from, Exxon Escorene™ EVA at a temperature of 145-150° C. The EVA resin comprises 9% by weight of vinyl acetate and has a density of 0.93 gm/cm³. The melt flow index of the EVA is 2.0 gms/10 min. The sealing temperature of the EVA is 110-160° C.

The gauge of the outer layer was between 20-30 microns and the gauge of the inner layer was 25-35 microns.

The film produced in Example 1 was a shrinkable film that provided a tight, smooth appearance to a product wrapped in the film. The film has an added toughness providing good abuse resistance. The film also had good optical properties after shrinking.

### EXAMPLE 2

A packaging film was produced in accordance with the process described above. The outer layer was extruded from the DuPont Surlyn 1601B2 resin, which has a density of 0.93 g/cm3 at a temperature of 165-185 C. The melt flow index of Surlyn is 0.13 g/10 min.

The inner layer was extruded from Exxon Escorene EVA at a temperature of 145-150 C. The EVA resin comprises 9% by weight of vinyl acetate and has a density of 0.93 g/cm3. The melt flow index of EVA is 2.0 g/10 min. The sealing temperature of the EVA is 110-160 C.

A blue masterbatch tint was added to the inner layer at a loading of 5 g/10 kg of EVA.

The gauge of the outer layer was between 20-30 microns and the gauge of the inner layer was 25-35 microns.

### EXAMPLE 3

A packaging film was produced in accordance with the process described above. The outer layer was extruded from the DuPont Surlyn 1601B2 resin, which has a density of 0.93 g/cm3 at a temperature of 165-185 C. The melt flow index of Surlyn is 0.13 g/10 min.

The inner layer was extruded from Exxon Escorene EVA at a temperature of 145-150 C. The EVA resin comprises 9% by weight of vinyl acetate and has a density of 0.93 g/cm3. The melt flow index of EVA is 2.0 g/10 min. The sealing temperature of the EVA is 110-160 C.

The gauge of the outer layer was between 35-55 microns and the gauge of the inner layer was 35-55 microns.

### EXAMPLE 4

A packaging film was produced in accordance with the process described above. The outer layer was extruded from the DuPont Surlyn 1601B2 resin, which has a density of 0.93 g/cm3 at a temperature of 165-185 C. The melt flow index of Surlyn is 0.13 g/10 min.

The inner layer was extruded from Exxon Escorene EVA at a temperature of 145-150 C. The EVA resin comprises 10% by weight of vinyl acetate and has a density of 0.93 g/cm3. The melt flow index of the EVA is 0.35 g/10 min. The sealing temperature of the EVA is 110-160 C.

The gauge of the outer layer was between 35-40 microns and the gauge of the inner layer was 30-40 microns.

Oriented multi-layer films in accordance with the invention have good abuse resistance, good optical properties, especially after shrinking, and good sealability making them especially suitable for packaging food, especially frozen red and white meat products.

An advantage of the films produced by this method is that they are lower cost to produce than oxygen barrier shrink bags which can also be used for packaging frozen meat products. The films also have excellent strength and puncture resistance properties. The films have an excellent colour and clarity and heat sealing properties.

Another advantage of the films of the present invention is that the first layer tends to have a natural tendency to shrink very slightly at room temperature relative to the second layer. This tendency means that the ends or cut edges of the film tend to curl slightly making it easier to locate the edge or end of the film. This also assists when one is wrapping or locating a food product in a tube of film.

Where in the foregoing description reference has been made to integers having known equivalents, then those equivalents are herein incorporated as if individually set forth.

Although the invention has been described with reference to specific embodiments, it is to be appreciated that variations and modifications may be made without departing from the spirit and scope of the invention.

1. A non-oxygen barrier packaging film including:
(a) an outer layer comprising an ionomer to provide thermal resistance and
(b) an inner layer comprising a polymeric material having a sealing temperature lower than the sealing temperature of said outer layer.

2. The packaging film according to claim 1 further including a core layer.

3. The packaging film according to claim 1 or claim 2 wherein said inner layer and said core layer may further include a tinting material.

4. The packaging film according to any one of claims 1 to 3 wherein the packaging film is transparent.

5. The packaging film according to any one of claims 1 to 4 wherein said inner layer or said core layer comprises a polymeric material selected from the group consisting of: ethylene vinyl acetate, linear low density polyethylene, low density polyethylene, very low density polyethylene, or metallocene catalysed polyethylenes and blends thereof.

6. The packaging film according to any one of claims 1 to 5 wherein said the packaging film has a gauge of between 19-120 microns.

7. The packaging film according to any one of claims 1 to 6 wherein said packaging film has a gauge of between 40-80 microns.

8. The packaging film according to any one of claims 1 to 7 wherein each layer of the packaging film has gauge of between 9-60 microns.

9. The packaging film according to any one of claims 1 to 8 wherein said packaging film is oriented.

10. The packaging film according to any one of claims 1 to 9 wherein said packaging film is biaxially oriented.

11. The packaging film according to any one of claims 3 to 10 wherein said tinting material is selected from a range of known dyes or pigments that are food approved additives.

12. A method of making a non-oxygen barrier packaging film which includes the steps of
(a) co-extruding a first layer comprising an ionomer and a second layer comprising a polymeric material having a sealing temperature lower than said first layer; and
(b) cooling the co-extruded film.

13. The method according to claim 12 including the further step of heating the co-extruded film to its orientation temperature range and stretching and orienting the heated film.

14. The method according to claim 12 or 13 wherein the co-extrusion step is a tubular co-extrusion step.

15. The method according to any one of claims 12 to 14 wherein the film produced in the tubular co-extrusion step is biaxially oriented and stretched by a trapped bubble technique.

16. The method according to any one of claims 12 to 14 wherein the film produced in the tubular co-extrusion step has said first layer as the outer layer and said second layer as the inner layer.

17. A method of packaging a food product, including the steps of
(a) taking a heat shrinkable film as defined in any one of claims 1 to 12;
(b) wrapping a food product in said film such that said first layer is the outer layer and said second layer is the inner layer;
(c) heat sealing together the edges of said film about said food product; after vacuum packaging; and
(d) heat shrinking said film about said food product.

18. The method as claimed in claim 17, wherein the film is a co-extruded tubular film and step (b) involves cutting a length of said tube and locating said food product within the tube.

19. The method as claimed in claim 18 wherein one end of the tubular film is heat sealed prior to locating the food product in the tube.

20. The method as claimed in any one of claims 17 to 19 wherein the film is a co-extruded tubular film and step (c) involves heat sealing each end of said tube.

21. The method as claimed in any one of claims 17 to 20 wherein said heat shrinking is achieved by a hot air stream or a hot water bath.

22. The method as claimed in any one of claims 17 to 21 wherein said method further includes the step of printing onto the outer layer of said film.
